(19) United States
(12) Patent Application Publication
(10) Pub. No.: US 2007/0166057 A1
(43) Pub. Date: Jul. 19, 2007

(54) Image forming apparatus and layer thickness measuring method

(75) Inventors: Hideki Moriya, Kanagawa (JP); Chikaho Ikeda, Kanagawa (JP); Hidehiko Yamaguchi, Kanagawa (JP); Masao Ohmori, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/519,826

(22) Filed: Sep. 13, 2006

(30) Foreign Application Priority Data
Jan. 13, 2006 (JP) 2006-006748

(51) Int. Cl. G03G 15/00

(52) U.S. Cl. 399/26

(57) ABSTRACT

An image forming apparatus includes: a photoconductor having a photoconductive layer on an outer surface thereof; a charging portion that charges the photoconductor; a developing portion that develops a latent image formed on the photoconductor; a transfer portion that transfers a developed image; current detectors respectively provided to the charging portion, the developing portion, and the transfer portion to detect currents respectively flowing from the charging portion, the developing portion, and the transfer portion to the photoconductor; an integrating portion that calculates a charge amount by integrating the currents detected by the current detectors over a given period of time; and a layer thickness calculating portion that calculates a thickness of the photoconductive layer based on the charge amount.

### BACKGROUND

1. Technical Field

This invention relates to an image forming apparatus in which an AC voltage is superimposed on a DC voltage to charge a photoconductor uniformly in a contact charging method or a close proximity charging method having the operation principle of discharging, and more particularly, to a measuring technique for thickness of a photoconductive layer of the photoconductor.

2. Related Art

Various members such as a charging roller, developing brash, and transferring roller, cleaning brush, cleaning blade, and the like physically come into contact with the surface of a photoconductor of an image forming apparatus. Such physical contact gradually wears away the surface of a photoconductive layer formed on the outer surface of the photoconductor along with the repeated image forming process. In particular, the magnitude of sliding frictional forces applied by the cleaning brush or cleaning blade is strong enough to cause the abrasion of the photoconductive layer.

With the afore-described abrasion, if the thickness of the photoconductive layer is reduced by a certain amount, the photosensitivity will significantly be weakened or the charging characteristics will be deteriorated. This makes it impossible to charge the surface of the photoconductor uniformly at a desired potential, and a clear image cannot be formed.

### SUMMARY

An aspect of the present invention provides an image forming apparatus including: a photoconductor having a photoconductive layer on an outer surface thereof; a charging portion that charges the photoconductor; a developing portion that develops a latent image formed on the photoconductor; a transfer portion that transfers a developed image; current detectors respectively provided to the charging portion, the developing portion, and the transfer portion to detect currents respectively flowing from the charging portion, the developing portion, and the transfer portion to the photoconductor; an integrating portion that calculates a charge amount by integrating the currents detected by the current detectors over a given period of time; and a layer thickness calculating portion that calculates a thickness of the photoconductive layer based on the charge amount.

### BRIEF DESCRIPTION OF THE DRAWINGS

Embodiments of the present invention will be described in detail based on the following figures, wherein:

FIG. 1 illustrates a configuration of an image forming apparatus;

FIG. 2 illustrates another configuration of an image forming apparatus;

FIG. 3 illustrates yet another configuration of an image forming apparatus; and

FIG. 4 is a flowchart of a layer thickness measuring procedure.

### DETAILED DESCRIPTION

A description will now be given, with reference to the accompanying drawings, of embodiments of the present invention.

### First Exemplary Embodiment

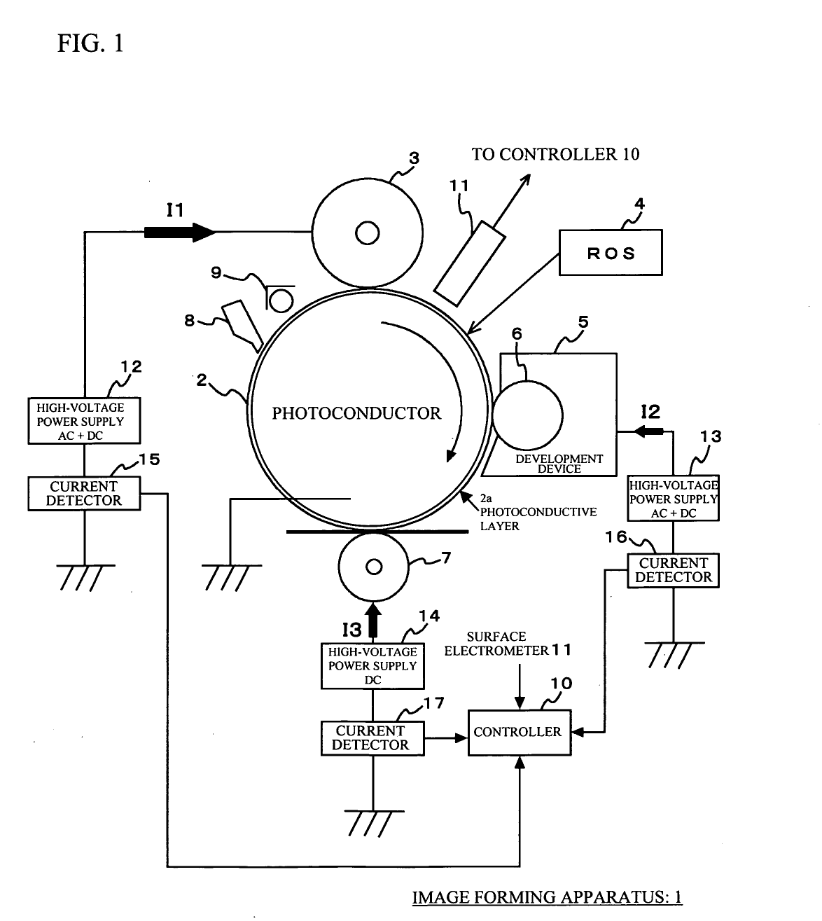

A description will be given of a configuration employed in the present exemplary embodiment, with reference to FIG. 1. A photoconductor 2 that serves as an image carrier is an OPC photoconductor having a shape of drum, and has a photoconductive layer 2a formed on its outer surface. The photoconductor 2 rotates in a clockwise direction, as indicated by an arrow, at a given process speed, namely, circumferential velocity, centering on a central axis thereof perpendicular to the paper surface.

There are provided a charging roll 3 in contact with the photoconductor 2, a Raster Optical Scanner (ROS) 4 that serves as an exposure device, a development device 5, a transfer roll 7, a cleaning blade 8, and a charge eliminating lamp 9, in the periphery of the photoconductor 2.

The charging roll 3 rotates in accordance with the rotation of the photoconductor 2. A high-voltage power supply 12 supplies voltage generated by superimposing AC on DC to uniformly charge an outer surface of such rotating photoconductor 2 to a given polarity and potential. In accordance with this exemplary embodiment, the photoconductor 2 is negatively charged.

Subsequently, a laser beam of a modulated image is output from the ROS 4 and irradiated (in the form of scanning exposure) onto the outer surface to be charged of such rotating photoconductor 2. The potential of an exposed portion is attenuated and an electrostatic latent image is formed.

When the latent image comes to a position for development that faces the development device 5 in accordance with the rotation of the photoconductor 2, negatively charged toner is supplied from a developing roll 6 of the development device 5 and a toner image is created by the reversal development.

In the downstream of the development device 5, when viewed from a rotational direction of the photoconductor 2, the conductive transfer roll 7 is arranged in press contact with the photoconductor 2, and a nip portion of the photoconductor 2 and the transfer roll 7 form a transfer portion.

When the toner image created on the surface of the photoconductor 2 reaches the afore-mentioned transfer portion in accordance with the rotation of the photoconductor 2, a sheet of paper is supplied to the transfer position at a synchronized timing. Simultaneously, a given voltage is applied to the transfer roll 7 and the toner image is transferred to the sheet from the surface of the photoconductor 2.

The sheet of paper on which the toner image is transferred at the transfer position is fed to a fixing device to fix the toner image on the surface of the paper, and is then output from the image forming apparatus.

Meanwhile, the residual toner on the surface of the photoconductor 2 after transfer is brushed off by the cleaning blade 8. The surface of the photoconductor 2 is cleaned for the next image forming process. The electrostatic latent image is deleted by the charge eliminating lamp 9.

A voltage, in which an AC voltage is superimposed on a DC voltage (hereinafter, simply referred to as AC+DC voltage) by the high-voltage power supply 12 for charge, is applied to the charging roll 3. A voltage, in which the AC+DC voltage applied by a high-voltage power supply 13 for development, is applied to the developing roll 6. In addition, a DC voltage is applied to the transfer roll 7 by a high-voltage power supply 14 for transfer.

Furthermore, the above described high-voltage power supplies 12, 13, and 14 are respectively provided with current detectors 15, 16, and 17 that measures the DC current respectively flowing across the rolls. The DC currents detected by the current detectors 15, 16, and 17 are output to a controller 10. The controller 10 integrates the DC currents measured by the current detectors 15, 16, and 17 over a given period of time to calculate a charge amount flown into the photoconductor.

In the present exemplary embodiment, as described above, the charging roll 3, the developing roll 6, and the transfer roll 7 are respectively provided with the current detectors 15, 16, and 17 to measure all the DC currents flowing into the photoconductor 2 and calculate the charge amount by integrating the DC currents over a given period of time. With the use of the charge amount, the thickness of the photoconductive layer 2a is detected.

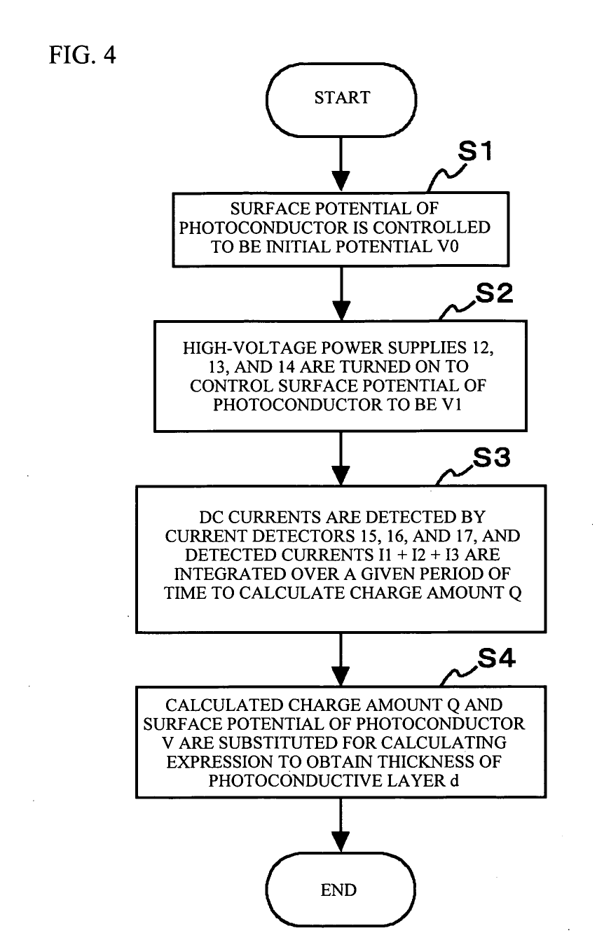

A description will be given of an operation procedure employed in the present exemplary embodiment, with reference to the flowchart shown in FIG. 4. Firstly, the surface potential of the photoconductor 2 is controlled to be an initial voltage V0 (step S1). Here, the surface potential of the pre-charged photoconductor 2 may be eliminated by the charge eliminating lamp 9 to be V0. Alternatively, AC+DC voltage may be supplied to the charging roll 3 by the high-voltage power supply 12 for charge so that the potential of the photoconductor 2 is set to V0. In addition, the high-voltage power supply 12 for charge, the high-voltage power supply 13 for development, and the high-voltage power supply 14 for transfer may all be turned on so that the potential of the photoconductor is set to V0.

Then, the high-voltage power supply 12 for charge, the high-voltage power supply 13 for development, and the high-voltage power supply 14 for transfer are turned on to control the surface potential of the photoconductor to be V1 (step S2). At this time, the DC current flowing across the photoconductor 2 is detected by the current detector 15 by using the AC+DC voltage supplied from the high-voltage power supply 12 for charge. Similarly, the DC current flowing across the photoconductor 2 is detected by the current detector 16 by using the AC+DC voltage supplied from the high-voltage power supply 13 for development. Also, the DC current flowing across the photoconductor 2 is detected by the current detector 17 by using the DC voltage supplied from the high-voltage power supply 14 for transfer. DC currents I1, I2, and I3 respectively correspond to the DC currents detected by the current detectors 15, 16, and 17. Accordingly, the current flowing across the photoconductor 2 is I1+I2+I3, and a charge amount Q is calculated by integrating the above-described current value over a given period of time (step S3). The charge amount Q is calculated by integrating the current flowing while the charged potential of the photoconductor becomes V1 from the initial potential V0. The current is integrated until the DC current flowing into the photoconductor 2 becomes 0 or constant. Alternatively, the current is accumulated until the surface potential of the photoconductor measured by a surface electrometer 11 becomes constant. Also, since the above-described period of time may change more or less according to the environment or the change over time of the photoconductor 2, a fixed time may be employed by setting to the maximum time among the times that change.

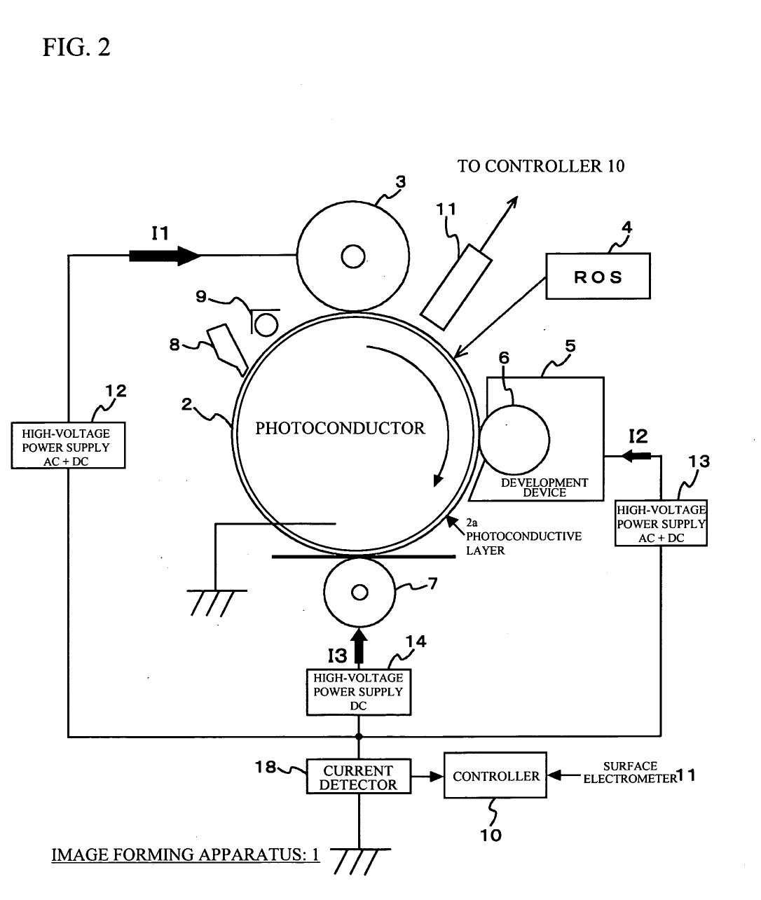

In the present exemplary embodiment, as shown in FIG. 1, the high-voltage power supplies 12, 13, and 14 are respectively provided with the current detectors 15, 16, and 17. However, referring now to FIG. 2, the respective power supplies are connected to a single current detector 18 so that the above-described DC current of I1+I2+I3 can be detected.

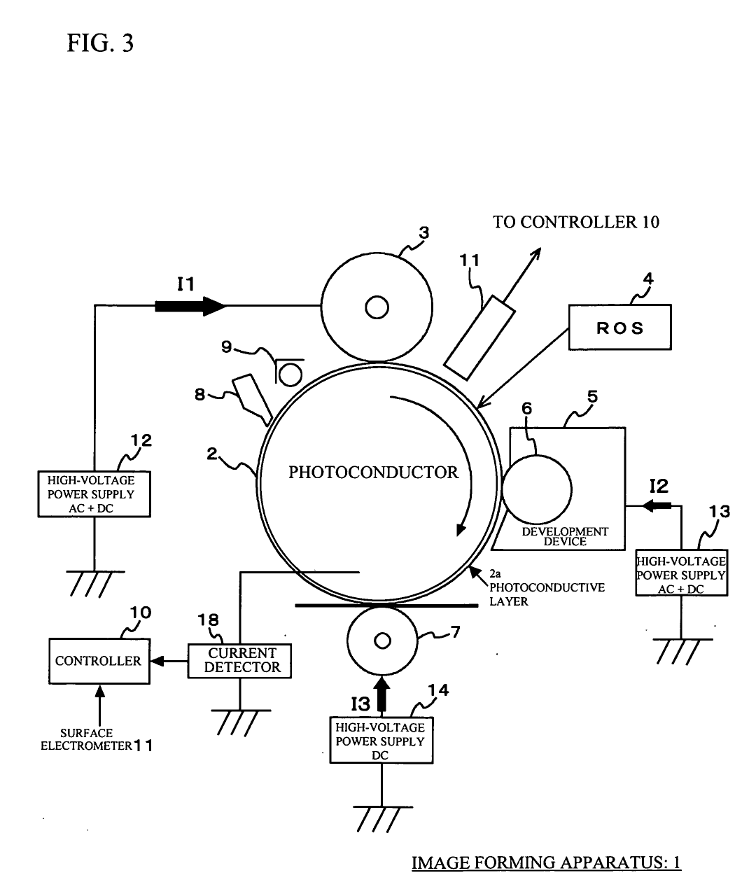

In addition, referring to FIG. 3, instead of connecting the current detector to the high-voltage power supply, the current detector 18 is provided between the photoconductor 2 and ground, and the DC current of I1+I2+I3 is measured in a similar manner.

In the exemplary embodiment shown in FIG. 1 through FIG. 3, the high-voltage power supply 13 for development and the high-voltage power supply 14 for transfer are also operated, in addition to the high-voltage power supply 12 for charge, when the charge amount Q is measured. However, if the developing roll 6 and the transfer roll 7 are respectively set to OFF state, it is only necessary to detect the current I1 by means of the current detector 15. In order to set the developing roll 6 and the transfer roll 7 to OFF state, the developing roll 6 and the transfer roll 7 may be mechanically separated from the photoconductor 2, the developing roll 6 and the transfer roll 7 may be set to have the same potentials as that of the photoconductor 2 to be electrically floating, or the high-voltage power supplies 13 and 14 may be controlled so that the current may not be flown into the photoconductor 2 from the developing roll 6 or the transfer roll 7.

Next, the thickness of the photoconductive layer 2a is calculated by using such detected DC current I1+I2+I3 (step S4) on the controller 10. The calculating expression is described as follows:

$$\begin{matrix}Charge amount Q = \int ( I 1 + I 2 + I 3 ) d t & ( 1 ) \\ C = V / Q & ( 2 ) \\ Thickness of photoconductive layer d = \frac{\begin{matrix}ɛ \times ( length of charging roll ) \times \\ ( diameter of photoconductor ) \times π\end{matrix}}{C} & ( 3 )\end{matrix}$$

where, C represents capacitance of the photoconductor 2, V represents the surface potential of the photoconductor 2, and ε represents a dielectric constant of the photoconductor 2.

The surface potential V of the photoconductor 2 is obtainable by measuring with the use of the surface electrometer 11. However, the surface electrometer is expensive and the surface potential V may be obtainable in the following method. The fact that the surface potential of the photoconductor 2 is identical to the DC voltage supplied when saturated is utilized. That is to say, the AC+DC voltage is generated on the high-voltage power supply 12 for charge and applied to the photoconductor 2. When the DC current I1 detected by the current detector 15 is 0, the surface potential of the photoconductor 2 equals the DC voltage applied.

Also, in a case where the initial thickness is known before the photoconductive layer 2a is worn out, the charge amount is measured before the photoconductive layer 2a is worn out and set as an initial charge amount. The thickness d is obtainable based on the ratio of the initial charge amount to the charge amount measured after the photoconductive layer 2a is worn out.

The thickness d of the photoconductive layer 2a=initial thickness X initial charge amount/detected charge amount. No parameter items are needed in the afore-described calculation method, thereby eliminating the individual difference of the photoconductor 2 or the charging roll 3 and enabling the thickness to be calculated with high accuracy.

If there is a leakage current passing through electrical wiring or the photoconductor 2 to ground, the DC current does not become 0 even in a state where the photoconductor 2 is fully charged, resulting in a constant current flow. Therefore, the charge loss due to the leakage current is calculated by integrating, in a similar manner, the currents I1, I2, and I3 flowing when the surface potential of the photoconductor 2 is saturated. Then, such calculated charge loss is deducted on the controller 10 to eliminate the effect of the leakage current.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a photoconductor having a photoconductive layer on an outer surface thereof;
a charging portion that charges the photoconductor;
a developing portion that develops a latent image formed on the photoconductor;
a transfer portion that transfers a developed image;
current detectors respectively provided to the charging portion, the developing portion, and the transfer portion to detect currents respectively flowing from the charging portion, the developing portion, and the transfer portion to the photoconductor;
an integrating portion that calculates a charge amount by integrating the currents detected by the current detectors over a given period of time; and
a layer thickness calculating portion that calculates a thickness of the photoconductive layer based on the charge amount.

2. An image forming apparatus comprising:
a photoconductor having a photoconductive layer on an outer surface thereof;
a charging portion that charges the photoconductor;
a developing portion that develops a latent image formed on the photoconductor;
a transfer portion that transfers a developed image;
a current detector connected to a power supply of the charging portion, the power supply of the developing portion, and the power supply of the transfer portion to detect currents respectively flowing from power supplies to the photoconductor;
an integrating portion that calculates a charge amount by integrating the currents detected by the current detector over a given period of time; and
a layer thickness calculating portion that calculates a thickness of the photoconductive layer based on the charge amount.

3. An image forming apparatus comprising:
a photoconductor having a photoconductive layer on an outer surface thereof;
a charging portion that charges the photoconductor;
a developing portion that develops a latent image formed on the photoconductor;
a transfer portion that transfers a developed image;
a current detector connected between the photoconductor and ground to detect a current flowing from the photoconductor;
an integrating portion that calculates a charge amount by integrating the current detected by the current detector over a given period of time; and
a layer thickness calculating portion that calculates a thickness of the photoconductive layer based on the charge amount.

4. The image forming apparatus as claimed in claim 1, further comprising a controller that controls power supplies so that the developing portion and the transfer portion are electrically floating, when the currents are detected by the current detectors.

5. The image forming apparatus as claimed in claim 2, further comprising a controller that controls the power supplies so that the developing portion and the transfer portion are electrically floating, when the currents are detected by the current detector.

6. The image forming apparatus as claimed in claim 3, further comprising a controller that controls power supplies so that the developing portion and the transfer portion are electrically floating, when the currents are detected by the current detector.

7. The image forming apparatus as claimed in claim 1, further comprising a controller that controls power supplies to supply voltages to the developing portion and the transfer portion so that a current is not flown to the photoconductor from the developing portion and the transfer portion or so that the current flowing across the photoconductor is constant, when the currents are detected by the current detectors.

8. The image forming apparatus as claimed in claim 2, further comprising a controller that controls the power supplies to supply voltages to the developing portion and the transfer portion so that a current is not flown to the photoconductor from the developing portion and the transfer portion or so that the current flowing across the photoconductor is constant, when the currents are detected by the current detector.

9. The image forming apparatus as claimed in claim 3, further comprising a controller that controls power supplies to supply voltages to the developing portion and the transfer portion so that the current is not flown to the photoconductor from the developing portion and the transfer portion or so that the current flowing across the photoconductor is constant, when the current are detected by the current detector.

10. The image forming apparatus as claimed in claim 1, wherein the layer thickness calculating portion calculates the thickness of the photoconductive layer by multiplying a ratio of the charge amount before the photoconductive layer is worn out and a detected charge amount with the thickness before the photoconductive layer is worn out to calculate the thickness of the photoconductive layer.

11. The image forming apparatus as claimed in claim 2, wherein the layer thickness calculating portion calculates the thickness of the photoconductive layer by multiplying a ratio of the charge amount before the photoconductive layer is worn out and a detected charge amount with the thickness before the photoconductive layer is worn out to calculate the thickness of the photoconductive layer.

12. The image forming apparatus as claimed in claim 3, wherein the layer thickness calculating portion calculates the thickness of the photoconductive layer by multiplying a ratio of the charge amount before the photoconductive layer is worn out and a detected charge amount with the thickness before the photoconductive layer is worn out to calculate the thickness of the photoconductive layer.

13. The image forming apparatus as claimed in claim 1, wherein the layer thickness calculating portion takes a current detected by at least one of the current detectors, even when the photoconductor is saturated, as a leakage current and the charge amount of the leakage current is deducted when the charge amount is calculated.

14. The image forming apparatus as claimed in claim 2, wherein the layer thickness calculating portion takes a current detected by at least one of the current detectors, even when the photoconductor is saturated, as a leakage current and the charge amount of the leakage current is deducted when the charge amount is calculated.

15. The image forming apparatus as claimed in claim 3, wherein the layer thickness calculating portion takes the current detected by at least one of the current detectors, even when the photoconductor is saturated, as a leakage current and the charge amount of the leakage current is deducted when the charge amount is calculated.

16. A layer thickness measuring method for an image forming apparatus comprising a photoconductor having a photoconductive layer on an outer surface thereof, a charging portion that charges the photoconductor, a developing portion that develops a latent image formed on the photoconductor and a transfer portion that transfers a developed image, the method comprising:
detecting currents respectively flowing from the charging portion, the developing portion and the transfer portion to the photoconductor;
calculating a charge amount by integrating the currents detected over a given period of time; and
calculating a thickness of the photoconductive layer based on the charge amount.

17. A layer thickness measuring method for an image forming apparatus comprising a photoconductor having a photoconductive layer on an outer surface thereof, a charging portion that charges the photoconductor, a developing portion that develops a latent image formed on the photoconductor and a transfer portion that transfers a developed image, the method comprising:
detecting currents respectively flowing from a power supply of the charging portion, a power supply of the developing portion, and a power supply of the transfer portion, to the photoconductor;
calculating a charge amount by integrating the currents detected over a given period of time; and
calculating a thickness of the photoconductive layer based on the charge amount.

18. A layer thickness measuring method for an image forming apparatus comprising a photoconductor having a photoconductive layer on an outer surface thereof, the method comprising:
detecting a current flowing from the photoconductor to ground;
calculating a charge amount by integrating the currents detected over a given period of time; and
calculating a thickness of the photoconductive layer based on the charge amount.
